(19) United States
(12) Patent Application Publication
(10) Pub. No.: US 2023/0173548 A1
(43) Pub. Date: Jun. 8, 2023

(54) MULTI-PURPOSE CLEANING SYSTEM

(71) Applicant: IKRAAN TECHNOLOGY PRIVATE LIMITED, Pune (IN)

(72) Inventors: Dinesh JAISINGHANI, Pune (IN); Govind JAISINGHANI, Pune (IN)

(73) Assignee: IKRAAN TECHNOLOGY PRIVATE LIMITED, Pune, (IN)

(21) Appl. No.: 17/923,860

(22) PCT Filed: May 6, 2021
(86) PCT No.: PCT/IB2021/053834

§ 371 Date: Nov. 7, 2022

(30) Foreign Application Priority Data
May 7, 2020 (IN) 202021019426

(51) Int. Cl. B08B 1/00; B08B 1/04; B08B 3/02; F24S 40/20; H02S 40/10

(52) U.S. Cl. CPC B08B 1/008; B08B 1/002; B08B 1/04; B08B 3/024; F24S 40/20; H02S 40/10

(57) ABSTRACT

A multi-purpose cleaning system for cleaning glasses/stickers/solar panels is disclosed. The disclosed cleaning system is based on a housing movably arranged on an object to be cleaned; cleaning elements to clean the object; rotary devices to enable movement of the housing across the object to facilitate cleaning of the object; a control unit configured to actuate the rotary devices; and a spring mechanism operatively coupled to the rotary devices. The spring mechanism is configured such that the spring mechanism either gets compressed or extended when the rotary devices are actuated to move the housing to clean a cleaning area of the object. A biasing spring force of the compressed or extended spring mechanism facilitates movement of the housing from the cleaning area of the object to be cleaned to a rest position on the object.

### CROSS-REFERENCE TO RELATED APPLICATIONS AND PRIORITY

The present application claims priority from an Indian Patent Application Number 202021019426 filed on 7 May 2020.

### TECHNICAL FIELD

The present disclosure relates generally to cleaning systems. More specifically, it pertains to an improved multi-purpose cleaning device which is easy to install for efficient cleaning of solar panels/stickers or window glasses.

### BACKGROUND

Background description includes information that may be useful in understanding the present invention. It is not an admission that any of the information provided herein is prior art or relevant to the presently claimed invention, or that any publication specifically or implicitly referenced is prior art.

A photovoltaic solar panel is made up of several solar cells mounted on a support, absorb sunlight as a source of energy which excite electrons in semiconductor material of solar cells to generate electricity. Accumulation of leaves such as bird poop, a layer of dirt, dust, pollen grains on surface of the solar panel diminishes intensity of solar radiation reaching the solar cells thereby decreasing efficiency of the solar panel. If the solar panel is not clean, then the solar panel absorbs less sunlight thereby less electricity is generated by the solar cells.

Efforts have been made in past to remove/clean the dust and foreign particles from the solar panels. For example, manual washing using water jets is often used. The major disadvantage of using the manual washing technique is that the technique is expensive and labour intensive, moreover, in gulf countries such as Saudi Arabia cost of one litre of water is three times that of one litre of petrol. Besides, the solar panels are turned to a maximum tilt angle early in morning or late in evening to let dust fall from the surface. Tilting technique of the solar panels is a complex and labour intensive technique requiring high precision of tilt angle at desired angle. Another cleaning technique involves compressed air by air compressors to blow away the dust of solar panel, which results in a lot of dust being suspended in air. In another technique for cleaning the solar panels employs brushes similar to windscreen wipers of motor cars to wipe the dust away, a drawback of this technique is bird droppings may not be cleaned using this techniques.

Apart from the above discussed manual cleaning for the solar panels, there are other many situations including glasses of building structures, particularly tall urban buildings/skyscrapers, are typically washed manually. A scaffolding structure is usually suspended from the top of the building to be washed. The scaffolding can be raised or lowered so that a person standing on the scaffolding can wash the windows and exterior surfaces of the building by hand.

Manual washing of the buildings has proven to be quite dangerous, especially with respect to tall skyscrapers. Typical wind and air drafts surrounding a building can exert a significant aerodynamic force upon the scaffolding structure or window cleaning person, causing them to swing out and away from the building. Injuries from manual window washing operations are common.

There is, therefore, a need in the art to provide a simple, compact and cost-effective multi-purpose cleaning device/system which can overcome the above mentioned problems.

### OBJECTS OF THE INVENTION

Some of the objects of the present disclosure, which at least one embodiment herein satisfies are as listed herein below.

A general object of the present disclosure is to provide an improved and efficient multi-purpose cleaning system which can overcome the above mentioned challenges in the art.

An object of the present disclosure is to provide an improved solar sticker/panel/glass cleaning system.

Another object of the present disclosure is to provide a multi-purpose cleaning device for cleaning solar panels/stickers or window glasses with minimal manual intervention.

Another object of the present disclosure is to provide a multi-purpose cleaning system which operates on basis of geographical areas and weather conditions in which the multi-purpose cleaning system is implemented to clean solar panels/stickers or glasses in order to reduce human intervention.

Yet another object of the present disclosure is to provide a simple and cost effective multi-purpose cleaning system for efficient cleaning of solar panels/stickers or glasses with minimal human intervention.

Still another object of the present disclosure is to provide an efficient multi-purpose cleaning system which consumes less energy compared to conventional cleaning system for cleaning solar panels/stickers or window glasses.

These and other objects of the present invention will become readily apparent from the following detailed description taken in conjunction with the accompanying drawings.

### SUMMARY

The present disclosure relates to cleaning devices. More specifically, it pertains to an improved multi-purpose cleaning system for efficient cleaning of solar panels/stickers or window glass with minimal human intervention.

In an aspect, the present disclosure provides a multi-purpose cleaning system which includes a housing having at least one cavity, the hosing being movably arranged on an object to be cleaned, and one or more cleaning elements coupled to a bottom object of the housing for cleaning the object to be cleaned when the housing moves across the object. The cleaning system can include one or more rotary devices configured for fitment in the at least one cavity of the housing, the one or more rotary devices being configured to enable movement of the housing across the object to be cleaned to facilitate cleaning of the object, and a control unit configured within the at least one cavity of the housing. The control unit is operatively coupled to the one or more rotary devices to actuate the one or more rotary devices to facilitate movement of the housing.

In an embodiment, the cleaning system includes a support structure movably configured on the object to be cleaned. The support structure is extended along a transverse direction of the object to be cleaned. The support structure is configured to support the housing.

In an embodiment, the object to be cleaned can be any of a solar panel, a window glass of buildings, stickers, etc.

In an embodiment, the cleaning system can include a spring mechanism operatively coupled to the one or more rotary devices. The spring mechanism can be configured such that the spring mechanism either gets compressed or extended when the one or more rotary devices are actuated to move the housing to clean a cleaning area of the object to be cleaned, wherein a biasing spring force of the compressed or extended spring mechanism facilitates movement of the housing from the object area of the object to be cleaned to a rest position on the object to be cleaned, thereby reducing power consumption by the system for cleaning the object.

In an embodiment, the control unit can include one or more processors and a memory storing a set of instructions executable by the one or more processors. The control unit can be configured to actuate the one or more rotary devices based on any or a combination of one or more parameters associated with a geographical areas in which the object to be cleaned is installed, weather conditions, input instructions received form one or more users, and one or more stored data in a database/memory operatively coupled to the control unit.

In an embodiment, the pre-stored data in the database can be associated with one or more predefined time and dates for cleaning the object to be cleaned, and one or more predefined time intervals for cleaning the object to be cleaned on the one or more pre-defined days.

In an embodiment, the cleaning system can include one or more sensors configured to senses one or more attributes of the object to be cleaned, and transmit signals to the control unit based on the sensed attributes of the object, wherein the one or more attributes of the object can include presence or dirt or foreign matters on the object to be cleaned, and real-time efficiency of the object to be cleaned when the object to be cleaned is either one or more solar panels, window glasses or stickers.

In an embodiment, the cleaning system can include a gear assembly operatively coupled to the one or more rotary devices.

In an embodiment, the one or more rotary devices are selected from a group of motors comprising AC motors, DC motors, steppers motors, servomotors and the like.

In an embodiment, the spring mechanism can include one or more springs.

In an embodiment, the cleaning system can include a set of ball bearing rotatably configured with walls of the housing, and one or more wheels coupled to shafts of the one or more rotary devices to allow movement of the housing on the solar panels.

In an embodiment, the one or more cleaning elements are any or combination of a brush, and a duster.

In an embodiment, the cleaning system can include a communication unit that can include at least one of a Bluetooth, Wi-Fi, X-bee, and a cellular network comprising any or combination of a Global System for Mobile Communications (GSM) cellular network, General Packet Radio Service (GPRS) cellular network, and Code-division multiple access (CDMA) cellular network units to facilitate commination between the control unit and computing devices of the one or more users.

In an embodiment, the cleaning system can include a user interface and a display unit operatively coupled to the control unit.

In an embodiment, the cleaning system can include a container to store a liquid for cleaning purpose and a sprayer coupled to the container. The cleaning system can also include a mounting structure for mounting the container and the sprayer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIGS. 1A to 1D illustrate exemplary representations of the proposed multi-purpose cleaning system, in accordance with embodiments of the present disclosure.

FIGS. 2A and 1B illustrate exemplary implementation of the proposed cleaning system, in accordance with embodiments of the present disclosure.

FIG. 3 illustrates a block diagram of a control unit of the proposed cleaning system, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by engines, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present disclosure relates to cleaning systems. More specifically, it pertains to a multi-purpose cleaning system which is easy to install for efficient cleaning of solar panels/stickers or window glasses.

In an aspect, the present disclosure provides a multi-purpose cleaning system which includes a housing having at least one cavity, the hosing being movably arranged on an object to be cleaned, and one or more cleaning elements coupled to a bottom object of the housing for cleaning the object to be cleaned when the housing moves across the object. The cleaning system can include one or more rotary devices configured for fitment in the at least one cavity of the housing, the one or more rotary devices being configured to enable movement of the housing across the object to be cleaned to facilitate cleaning of the object, and a control unit configured within the at least one cavity of the housing. The control unit is operatively coupled to the one or more rotary devices to actuate the one or more rotary devices to facilitate movement of the housing.

In an embodiment, the cleaning system includes a support structure movably configured on the object to be cleaned. The support structure is extended along a transverse direction of the object to be cleaned. The support structure is configured to support the housing.

In an embodiment, the object to be cleaned can be any of a solar panel, a window glass of buildings, stickers, etc.

In an embodiment, the cleaning system can include a spring mechanism operatively coupled to the one or more rotary devices. The spring mechanism can be configured such that the spring mechanism either gets compressed or extended when the one or more rotary devices are actuated to move the housing to clean a cleaning area of the object to be cleaned, wherein a biasing spring force of the compressed or extended spring mechanism facilitates movement of the housing from the object area of the object to be cleaned to a rest position on the object to be cleaned, thereby reducing power consumption by the system for cleaning the object.

In an embodiment, the control unit can include one or more processors and a memory storing a set of instructions executable by the one or more processors. The control unit can be configured to actuate the one or more rotary devices based on any or a combination of one or more parameters associated with a geographical areas in which the object to be cleaned is installed, weather conditions, input instructions received form one or more users, and one or more stored data in a database/memory operatively coupled to the control unit.

In an embodiment, the pre-stored data in the database can be associated with one or more predefined time and dates for cleaning the object to be cleaned, and one or more predefined time intervals for cleaning the object to be cleaned on the one or more pre-defined days.

In an embodiment, the cleaning system can include one or more sensors configured to senses one or more attributes of the object to be cleaned, and transmit signals to the control unit based on the sensed attributes of the object, wherein the one or more attributes of the object can include presence or dirt or foreign matters on the object to be cleaned, and real-time efficiency of the object to be cleaned when the object to be cleaned is either one or more solar panels, window glasses or stickers.

In an embodiment, the cleaning system can include a gear assembly operatively coupled to the one or more rotary devices.

In an embodiment, the one or more rotary devices are selected from a group of motors comprising AC motors, DC motors, steppers motors, servomotors and the like.

In an embodiment, the spring mechanism can include one or more springs.

In an embodiment, the cleaning system can include a set of ball bearing rotatably configured with walls of the housing, and one or more wheels coupled to shafts of the one or more rotary devices to allow movement of the housing on the solar panels.

In an embodiment, the one or more cleaning elements are any or combination of a brush, and a duster.

In an embodiment, the cleaning system can include a communication unit that can include at least one of a Bluetooth, Wi-Fi, X-bee, and a cellular network comprising any or combination of a Global System for Mobile Communications (GSM) cellular network, General Packet Radio Service (GPRS) cellular network, and Code-division multiple access (CDMA) cellular network units to facilitate commination between the control unit and computing devices of the one or more users.

In an embodiment, the cleaning system can include a user interface and a display unit operatively coupled to the control unit.

In an embodiment, the cleaning system can include a container to store a liquid for cleaning purpose and a sprayer coupled to the container. The cleaning system can also include a mounting structure for mounting the container and the sprayer.

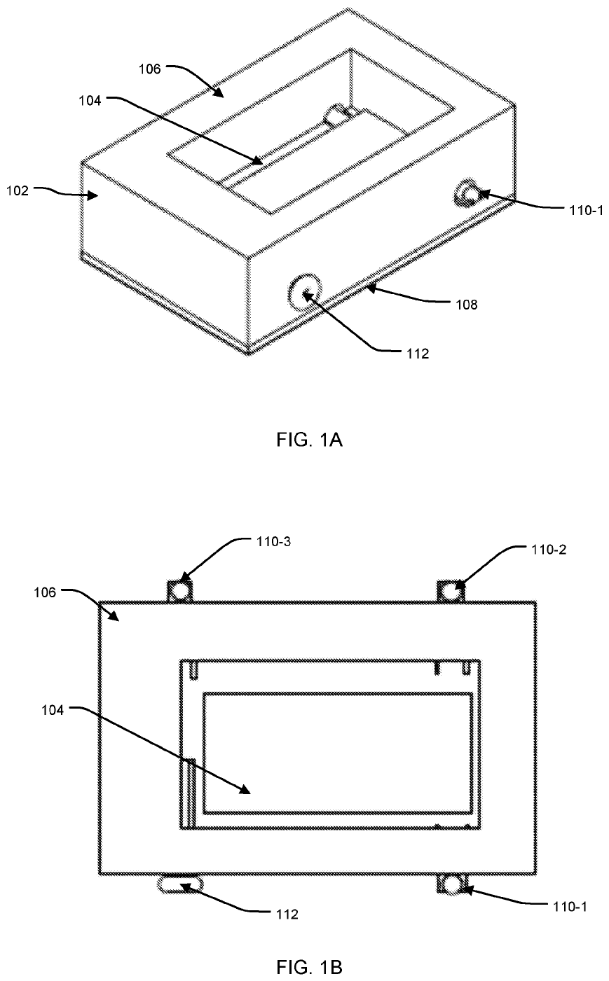

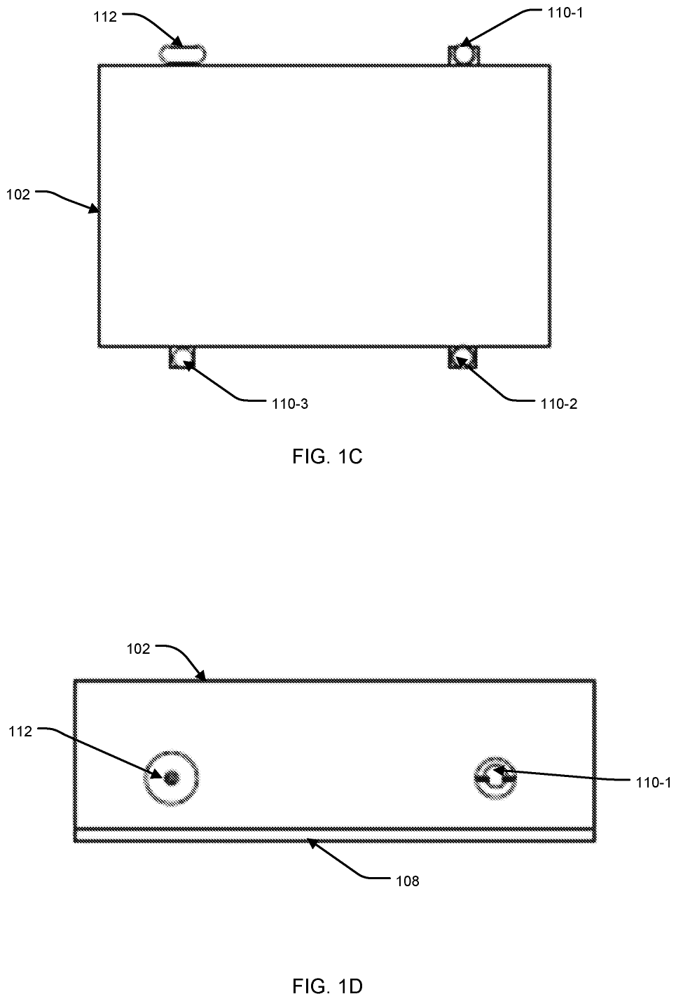

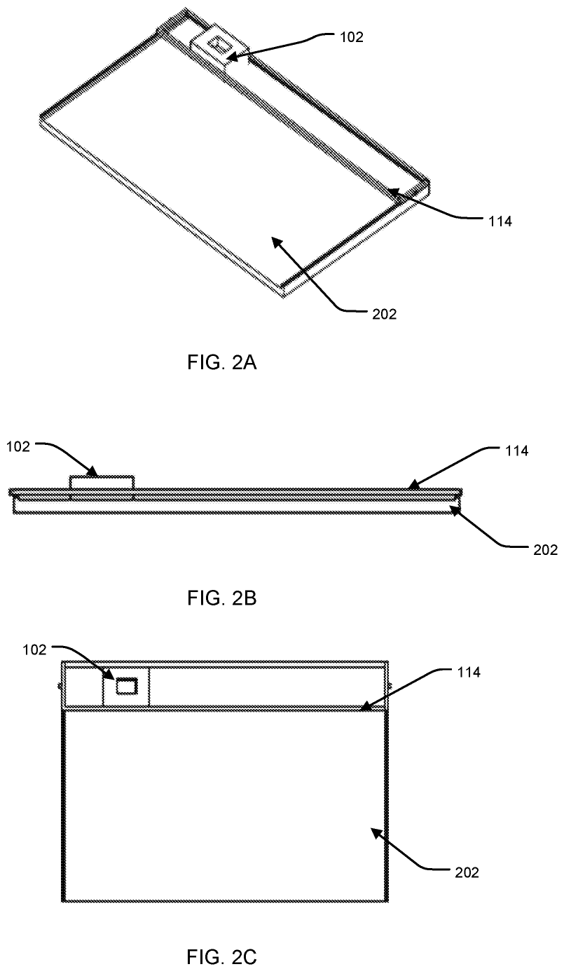

FIGS. 1A to 1D illustrate exemplary representations of the proposed multi-purpose cleaning system, in accordance with embodiments of the present disclosure. The disclosed cleaning system can include a housing 102 movably arranged on the one or more solar panels/window glasses/stickers. In one embodiment, the housing 102 can be arranged on an object such as a solar panel 202 (shown in FIG. 2A to 2C). The housing 102 can incorporates at least one cavity including an internal cavity (not shown) and external cavity 104 to accommodate components of the disclosed cleaning system, and a projection surface 106 surrounding the external cavity 104. Solar stickers are mounted on the projection surface 106 to power electronic components of the cleaning system. The cleaning system includes one or more cleaning elements, such as a cleaning element 108 coupled to a bottom surface of the housing 102 for cleaning the solar panels when the housing 102 moves across the solar panel 202.

In an embodiment, the cleaning element 108 can be any of a brush, a duster, and the like.

In an embodiment, the cleaning system can comprise a mounting arrangement for a sprayer and container. The container can store any liquids that may be useful for cleaning purpose. The sprayer may be connected to the container and spray the stored liquid on the surface to be cleaned. Thus, liquid cleaning can enable cleaning/removal of any sticky or semi-solid matter (such as thick mud, bird's poop, etc.) from the surface.

In an embodiment, the cleaning system includes a support structure 114 (shown in FIGS. 2A to 2C) movably configured on the solar panel 202. The support structure 114 is extended along a transverse direction of the solar panel 202. The support structure is configured to support the housing 102.

In an exemplary embodiment, the support structure 114 can be a rectangular shaped frame. In an exemplary embodiment, the support structure 114 can be a rectangular shaped guide rail for the housing 102.

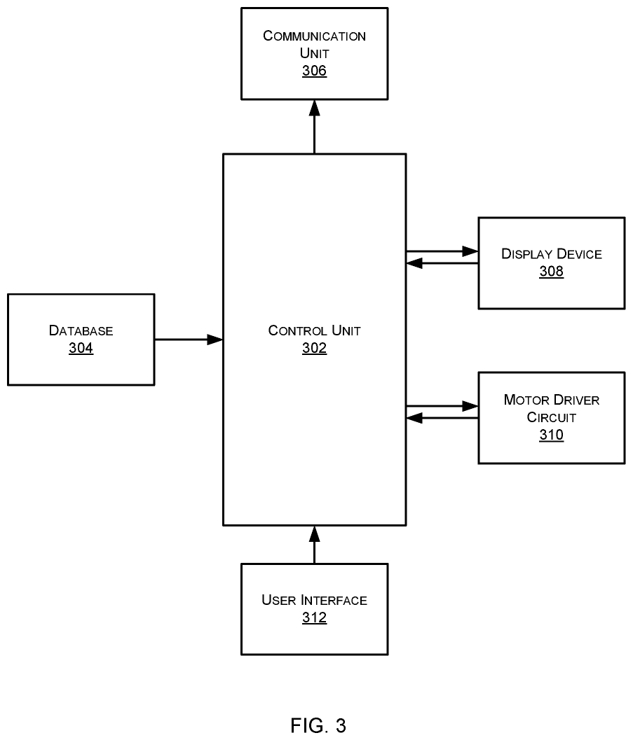

In an embodiment, the cleaning system further includes one or more rotary devices (not shown) configured for fitment in the internal cavity of the housing 102. The rotary devices are configured to enable movement of the housing 102 across the solar panels 202 to facilitate cleaning of the solar panel, and a control unit (shown in FIG. 3) configured for fitment in the external cavity 104 of the housing 102. The control unit is operatively coupled to the rotary devices to actuate the one or more rotary devices to facilitate movement of the housing 102 for cleaning the solar panel 202.

In an embodiment, the rotary devices can be selected from a group of motors comprising AC motors, DC motors, steppers motors, servomotors and the like.

In an embodiment, the cleaning system can include a gear assembly operatively coupled to the rotary devices. The gear assembly can be located in the internal cavity of the housing.

In an embodiment, the cleaning system can include a set of ball bearing (also referred to as neutral run ball baring) which includes a ball bearing 110-1, a ball bearing 110-2, and a ball bearing 110-3 (collectively referred to as bearings 110), and one or more wheels, such as a wheel 112 coupled to a shaft of the rotary device. The bearings 110 rotatably may be configured with walls of the housing 102. The bearings 110 and the wheel 112 are configured to allow movement of the housing 102 on the solar panels when the rotary device is actuated/Turned ON to clean the solar panel.

In an embodiment, the cleaning system can include a spring mechanism (not shown) configured in the internal cavity of the housing 102. The spring mechanism can be operatively coupled to the rotary device of the cleaning system. The spring mechanism can be configured such that the spring mechanism either gets compressed or extended when the one or more rotary devices are actuated to move the housing 102 to clean a surface area of the solar panel 202 to be cleaned. A biasing spring force of the compressed or extended spring mechanism facilitates movement of the housing 102 from the surface area of the solar panels to be cleaned to a rest position on a on the solar panels, thereby reducing power consumption by the system for cleaning the solar panel 202. Ideally, the conventional cleaning devices consume energy in two stages, first to reach out the area to be cleaned and secondly while returning back to its original position. In this case, the rotary devices and the spring mechanism use the energy while reaching out to the surface to be cleaned, and as regards to reaching to the original position, the device is based on the pushing/pulling of the spring. Thus, it may save almost half of the energy used to move as compared to the conventional cleaning devices.

For example, a ratio of dimensions of the window glass or solar panel with the cleaning brush can be 4:1. In order to clean the whole glass/panel, the brush has to move 4 times in horizontal manner. Cleaning can take place such that: (a) at first, brush cleans from right to left (cleaning may start either from top right corner or bottom right corner); (b) the mechanism enables brush movement in upward or downward direction (as the case may be), the movement may be equal to height of the cleaning brush; (c) with the stored energy of spring (if compressed), the spring enables the brush moves left to right, thus saving 50% of power of motors; and (d) similarly, the brush moves in vertical direction (upward or downward) and then cleans the remaining portion of the glass/panel.

In an embodiment, the cleaning system is designed to operate with least energy requirements. Unlike most of the cleaners, the cleaning system may operate using the energy which is being generated on an on-going basis from the solar panels, stickers, paints, building, exterior glasses, glass surfaces, etc. Due to this, the power harnessed would continue to be in the reserves and can be used for other purposes.

It would be appreciated that the disclosed cleaning system is a multipurpose cleaning system, and can be used for other applications such as for cleaning window glasses of building structures, particularly tall urban buildings/skyscrapers with suitable modifications, and all such variations are covered within scope of the present disclosure without any limitations. Thus, the proposed multipurpose cleaning system would significantly reduce operational window cleaning costs of and be considerably safer.

In an embodiment, the housing 102 can serve two purposes. At first, it is responsible to keep the cleaning system concealed, and improve aesthetic aspect to the cleaning system. The second benefit of the housing is that the housing 102 protects components of the system from damage owing to sudden impact from any foreign object. The housing 102 also protect the components of the cleaning system from weather conditions and thus prevent it from rusting and other such effects of weather. Eventually, the housing 102 increases the life and performance of the cleaning system.

In an embodiment, the housing 102 can be made of metal or metal alloys.

In an embodiment, plurality of the cleaning systems may be implemented for cleaning either window glass, solar panels or stickers. The plurality of the cleaning systems may be operated in either in synchronization or independently, with respect to each other.

Referring to FIG. 3 where a block diagram of a control unit with other units of the proposed cleaning system is shown. In an embodiment, the cleaning system can include a control unit 302 to control operation of the rotary device of the cleaning system. In an embodiment, the control unit can include one or more processors. The one or more processor may be implemented as one or more microprocessors, microcomputers, microcontrollers, digital signal processors, central processing units, logic circuitries, and/or any devices that manipulate data based on operational instructions. Among other capabilities, the one or more processors are configured to fetch and execute computer-readable instructions stored in a memory of the control unit 302. The memory may store one or more computer-readable instructions or routines, which may be fetched and executed to create or share the data units over a network service. The memory may comprise any non-transitory storage device including, for example, volatile memory such as RAM, or non-volatile memory such as EPROM, flash memory, and the like.

The control unit 302 may also include an interface. The interface may include a variety of interfaces, for example, interfaces for data input and output devices, referred to as I/O devices, storage devices, and the like. The interface may facilitate communication of the control unit 302 with various devices/computing devices coupled to the control unit 302 such as user computing devices. The interface may also provide a communication pathway for one or more components of the control unit 302. Examples of such components include, but not limited to, a database/external memory 304.

In an embodiment, the control unit 302 may be implemented as a combination of hardware and programming (for example, programmable instructions) to implement one or more functionalities of the control unit 302. In examples described herein, such combinations of hardware and programming may be implemented in several different ways. For example, the programming for the control unit 302 may be processor executable instructions stored on a non-transitory machine-readable storage medium and the hardware for the control unit 302 may comprise a processing resource (for example, one or more processors), to execute such instructions. In the present examples, the machine-readable storage medium may store instructions that, when executed by the processing resource, implement the control unit 302. In such examples, the control unit 302 may comprise the machine-readable storage medium storing the instructions and the processing resource to execute the instructions, or the machine-readable storage medium may be separate but accessible to the control unit 302 and the processing resource. In other examples, the control unit 302 may be implemented by electronic circuitry.

In an embodiment, the cleaning system can include a communication unit 306 operatively coupled to the control unit, a display unit/device 308, such as a LCD display operatively coupled to the control unit, a motor driver circuit 310 operatively coupled to the control unit 302, and a user interface 312 operatively coupled to the control unit 302.

The control unit 302 can be configured to actuate the rotary devices of the cleaning system based on any or a combination of one or more parameters associated with a geographical areas in which the solar panel 202 is installed, weather conditions, input instructions received form one or more users, one or more stored data in the database/memory 304 operatively coupled to the control unit 302, and signals received from one or more sensors. The database 304 may comprise data that is either stored or generated as a result of functionalities implemented by any of the components of the control unit 302. The database 304 can be a memory or server. The database 304 can be a coupled to the control unit 302 or located at a remote location.

In an embodiment, the one or more parameters associated with the geographical area can be type of land of the geographical area, pollution level, wind conditions and the like. The disclosed cleaning system can receive updates of the geographical and weather conditions from a server, thus, the control unit 302 takes into consideration of all such factors and accordingly initiate the cleaning protocols. For example, the cleaning system in desert area might activate cleaning more frequently since the area has a lot of dust and wind. Likewise, in a hilly area, the cleaning can be less frequent as there is rarely any dust or pollution being accumulated on the solar panel.

In an embodiment, the pre-stored data in the database 304 can be associated with one or more predefined time and dates for cleaning the one or more solar panels, and one or more predefined time intervals for cleaning the one or more solar panels on the one or more pre-defined days.

In an embodiment, the cleaning system can include one or more sensors (not shown) configured to senses one or more attributes of the solar panel 202, and transmit signals to the control unit 302 based on the sensed attributes of the solar panel 202. The one or more attributes of the solar panels can include presence or dirt or foreign matters on the solar panel, and real-time efficiency of the solar panel. Though the cleaning system performs regular cleanings based on weather conditions, there can be situations where the surface gets contaminated irrespective of weather conditions. For example, a bird poop, and/or a person drops his drink or food on the surface of solar panel, etc. Such factors may not being a geographical or weather related issue. However, in such scenarios, the sensors get activated and based on the sensor input signals, the control unit can actuate the cleaning system to initiate cleaning of the specific area. Thus, cleaning system can be an automatic cleaning system.

In an embodiment, the cleaning system can further include additional accessories comprising a sprayer and container adopted to store any cleaning liquid/water. The sprayer can be coupled to the container and spray the liquid on the surface to be cleaned. Thus, cleaning with liquid can enable cleaning/removal of any sticky or semi-solid matter (such as thick mud, bird's poop, etc.) from the surface.

In an embodiment, the communication unit 306 can include at least one of a Bluetooth, Wi-Fi, X-bee, and a cellular network comprising any or combination of a Global System for Mobile Communications (GSM) cellular network, General Packet Radio Service (GPRS) cellular network, and Code-division multiple access (CDMA) cellular network units to facilitate commination between the control unit and computing devices of the one or more users.

In an embodiment, the control unit 302 with the help of continuous communication with computing devices of the one or more users and self-learning may take action for cleaning, also making itself partial and/or full off as and when required along with necessary primitive measures as per power availability conditions.

In an embodiment, the control unit 302 may increases solar energy generation/efficiency by automatically taking decision by comparing energy generation of adjacent equivalent solar panels.

In an embodiment, to the control unit 302, the received/pre-stored instructions, for example operational algorithms, which may provide action plan for cleaning with respect to various permutation and combinations of environmental conditions like sun light, temperature, dust presence etc.

In an embodiment, operation of the cleaning system can be manually controlled with the help of the user interface/Human-Machine Interface (HMI) 312 in case external measure is to be taken. Thus, the control unit 302 or operation of the cleaning system can be controlled through a web page, manually with physical presence, as well as auto itself.

In an embodiment, the cleaning system with the help of spring action and by utilizing gravitational force may consume less energy for cleaning purpose and as it may avoid cleaning at night to avoid use of stored power.

In an embodiment, the solar panel stickers can get cleaned automatically after specific period according to geographical area into which the system is implemented.

In an exemplary embodiment, a user of the cleaning system using the control unit can make solar panel/window glass/sticker surface cleaning related settings. For example, (a) set date and time, from the user computing device/external software, the user can set date and time for cleaning, (b) weekly off, half day settings: if user want to declare non cleaning day or non-cleaning half day for a year then, can declare multiple weekly off, (C) store solar sticker/panel or window glass surface cleaning time for a year: the user can store in the database 304 solar sticker surface cleaning time for a year, (d) store half day solar sticker surface cleaning: if half day is declared before, then store half day solar sticker surface cleanings in the database. After uploading solar panel/sticker or window glass surface cleanings in the control unit, it may automatically set declared half day solar panel/sticker or window glass surface cleanings, (e) store solar panel/sticker or window glass surface cleaning time for a day: the user can store solar sticker surface cleaning time at a particular date. After storing solar sticker/panel or window glass surface cleaning time user can upload solar sticker/panel or window glass surface cleaning time by selecting that particular date by using upload solar panel/sticker or window glass surface cleaning time form. (f) download solar sticker/panel or window glass surface cleaning time: the user can download solar sticker/panel or window glass surface cleaning time in the computing device by selecting particular date or for a whole year, (g) upload solar sticker surface/panel or window glass cleaning time: if user want to see present solar sticker/panel or window glass surface cleanings time in software/computing device then user can upload that solar sticker/panel or window glass surface cleanings time from hardware to software as per software command.

In an embodiment, the user can create new user ID, delete existing user ID, change authentication password by changing setting of control unit authentication. Only an authorized user can create new user ID, delete the existing user ID and can change password.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides an improved and efficient multi-purpose cleaning system which can overcome the foregoing challenges in the art.

The present disclosure provides an improved multi-purpose panel cleaning device for efficient cleaning of solar panels/stickers or glasses.

The present disclosure provides an improved multi-purpose sticker/panel or window glass cleaning system

The present disclosure provides a multi-purpose cleaning system for cleaning solar panels/stickers or glasses with minimal manual intervention.

The present disclosure provides a multi-purpose cleaning system which operates on basis of geographical areas and weather conditions in which the multi-purpose cleaning system is implemented to clean solar stickers/panels or glasses in order to reduce human intervention.

The present disclosure provides a simple and cost effective multi-purpose cleaning device for efficient cleaning of solar stickers/panels or glasses with minimal human intervention.

The present disclosure provides an efficient multi-purpose cleaning system which consumes less energy compared to conventional cleaning system for cleaning solar stickers/panels or widow glasses.

1. A multi-purpose cleaning system, the cleaning system comprising:
a housing having at least one cavity, the hosing being movably arranged on an object to be cleaned;
one or more cleaning elements coupled to a bottom object of the housing, the one or more cleaning elements being configured to clean the object;
one or more rotary devices configured for fitment in the at least one cavity of the housing, the one or more rotary devices being configured to enable movement of the housing across the object to facilitate cleaning of the object to be cleaned;
a control unit configured within the at least one cavity of the housing, the control unit being operatively coupled to the one or more rotary devices to actuate the one or more rotary devices; and
a spring mechanism operatively coupled to the one or more rotary devices, the spring mechanism being configured such that the spring mechanism either gets compressed or extended when the one or more rotary devices are actuated to move the housing to clean a cleaning area of the object to be cleaned;
wherein a biasing spring force of the compressed or extended spring mechanism facilitates movement of the housing from the cleaning area of the object to be cleaned to a rest position on the solar panels.

2. The cleaning system as claimed in claim 1, wherein the object to be cleaned is any of a solar panel, a window glass of buildings, and stickers.

3. The cleaning system as claimed in claim 1, wherein the control unit comprises one or more processors and a memory storing a set of instructions executable by the one or more processors, and wherein the cleaning system comprises a user interface and a display unit operatively coupled to the control unit.

4. The cleaning system as claimed in claim 1, wherein the control unit is configured to actuate the one or more rotary devices based on any or a combination of one or more parameters associated with a geographical areas in which the object to be cleaned is installed, weather conditions, input instructions received form one or more users, and one or more pre-stored data in a database operatively coupled to the control unit.

5. The cleaning system as claimed in claim 4, wherein the pre-stored data in the database is associated with one or more predefined time and dates for cleaning the object to be cleaned, and one or more predefined time intervals for cleaning the object on the one or more pre-defined days.

6. The cleaning system as claimed in claim 1, wherein the cleaning system comprises one or more sensors configured to senses one or more attributes of the object to be cleaned, and transmit signals to the control unit based on the sensed attributes of the object to be cleaned, wherein the one or more attributes of the object comprises presence or dirt or foreign matters on the object, and real-time efficiency of the object to be cleaned.

7. The cleaning system as claimed in claim 1, wherein the cleaning system comprises a gear assembly operatively coupled to the one or more rotary devices, and wherein the one or more cleaning elements are any or combination of a brush, and a duster.

8. The cleaning system as claimed in claim 1, wherein the cleaning system comprises a set of ball bearing rotatably configured with walls of the housing, and one or more wheels coupled to shafts of the one or more rotary devices.

9. The cleaning system as claimed in claim 1, wherein the one or more rotary devices are selected from a group of motors comprising AC motors, DC motors, steppers motors and servomotors, wherein the spring mechanism comprises one or more springs.

10. The cleaning system as claimed in claim 1, wherein the cleaning system comprises a communication unit comprising at least one of a Bluetooth, Wi-Fi, X-bee, and a cellular network comprising any or combination of a Global System for Mobile Communications (GSM) cellular network, General Packet Radio Service (GPRS) cellular network, and Code-division multiple access (CDMA) cellular network units to facilitate commination between the control unit and computing devices of the one or more users.

11. The cleaning system as claimed in claim 1, wherein the cleaning system comprises a support structure movably configured on the object to be cleaned, wherein the support structure is configured to support the housing.

12. The cleaning system as claimed in claim 1, wherein the cleaning system comprises a container to store a liquid for cleaning purpose and a sprayer coupled to the container.
